(19) United States
(12) Patent Application Publication
(10) Pub. No.: US 2012/0232928 A1
(43) Pub. Date: Sep. 13, 2012

(54) ARRANGEMENT FOR IDENTIFICATION OF MEDICAL STATUS

(75) Inventor: Tony JOHANSSON, Ekero (SE)

(73) Assignee: MEDTECH INTERNATIONAL, LLC, Knoxville, TN (US)

(21) Appl. No.: 13/409,785

(22) Filed: Mar. 1, 2012

Related U.S. Application Data
(60) Provisional application No. 61/449,780, filed on Mar. 7, 2011.

(51) Int. Cl. G06Q 50/24

(52) U.S. Cl. 705/3

(57) ABSTRACT

An arrangement for identification of the medical status of a person in case of an accident, said arrangement including: a database where information regarding a specific persons medical status and/or medicaments taken on a regular basis by the person of relevance in case of emergency treatment is stored; passive identification means that make it possible to single out a person and collect the relevant information in the database for the identified person; a signal network for transmitting the required information to and from the database; a scanning device that is able to scan one or more injured persons to read the identification means, said scanning device also includes a transmitter/receiver communicating with the database and displays information; an auto reply service provider that verifies the scanned and transmitted request from the scanning device to the database, retrieves the information from the database and sends it to the scanning device.

### CROSS-REFERENCE TO RELATED APPLICATIONS

The present application is claims the benefit of U.S. Provisional Application No. 61/449,780, filed on 7 Mar. 2011. The entire contents of U.S. Provisional Application No. 61/449,780 are hereby incorporated herein by reference.

### FIELD OF THE INVENTION

The present invention relates to an arrangement and method for identification of the medical status of a person in case of an accident or acute illness.

### BACKGROUND OF THE INVENTION

Severe accidents' involving one or more peoples sometimes happens, for example in the traffic. In order to minimize the permanent injuries as well as extended hospitalization and/or saving lives, quick and adequate actions of the emergency medical personnel/technicians are essential.

There are some different solutions available on the market today that aim to facilitate for the emergency personnel to take the right action and speed up the treatment of injured peoples. One of these solutions is used for already registered patients that are provided with for example cards, necklaces or bracelets carrying written or active signal information about the medical status of the wearer. Unfortunately sometimes it is very time consuming and risky to find and identify the information from these objects, especially if the wearer is severely injured and needs to be moved in order to find this information.

Furthermore the lack of information also for people without a medical condition prevents emergency personnel from carrying out the full, required action.

There is consequently a need for an improved arrangement that establishes, or speeds up the procedure of identifying the medical status of the injured person and thereby decides, or reduces the time to take the right course of action in the treatment of the person.

### SUMMARY OF THE INVENTION

The needs defined above are to at least some extent fulfilled by an arrangement according to the definition in the independent claim.

The claimed arrangement saves time in emergency situations and assists in taking the correct actions quickly. The arrangement makes it possible to take the pre-accident medical status of the person in consideration, or verify that the person is healthy which in the end will save lives and reduce hospitalization and/or the risk of future permanent conditions.

With the right, quick actions taken at site of accident the social and financial savings for the society should be significant on numerous levels.

The claimed arrangement for identification of the medical status of a person in case of an accident comprises:
a database where information regarding a specific persons medical status and/or medicaments taken on a regular basis by the person of relevance in case of emergency treatment is stored;
passive identification means that make it possible to identify the person and collect the relevant information in the database for the identified person;
a signal network for transmitting the required information to and from the database;
a scanning device that is able to scan one or more injured persons to read the identification means, said scanning device comprises a transmitter/receiver communicating with the database.
an auto reply service provider that verifies the scanned and transmitted request from the scanning device to the database, retrieves the information from the database and sends it to the scanning device;
wherein, in case of an accident, the scanning device is used for scanning the injured person and when the identification means is indicated immediately communicate with the database via the signal network and the auto reply service provider receive information regarding the medical status of the person scanned.

In one embodiment of the arrangement, the arrangement furthermore comprises a reader/issuer of identifications means that records the unique code for the person being issued with said identification means. This embodiment facilitates the process of matching the information in the database with the passive identification means and ensures the desired safety of the arrangement since the identification means and the information in stored in the database are matched by the arrangement.

In one embodiment of the arrangement, the arrangement furthermore comprises a standard software form that is used for filling in the medical status of a person before it, after verification, is submitted to the database where the information is stored. This embodiment makes it easy to fill the relevant information regarding the medical status correctly in the form.

The present invention furthermore relates to a method for identification of the medical status of a person in case of an accident using an arrangement according to anyone of the embodiments above. The method comprises the steps: a) register and issue of identification means; b) submit medical status of a person to the database; c) scan the person with a scanning device; d) send a request regarding the medical status of the scanned person via a signal network through an auto reply service provider to the database; e) verify that the scanning device is authorized to receive information from the database, and f) send information regarding medical status from the database to the scanning device;

In one embodiment of the method, said information regarding medical status of the person is sent to the database by use of a standard software form in order to facilitate and ensure that the information is entered correctly in the database.

Further details of the arrangement will be described in the detailed description.

### BRIEF DESCRIPTION OF THE DRAWINGS

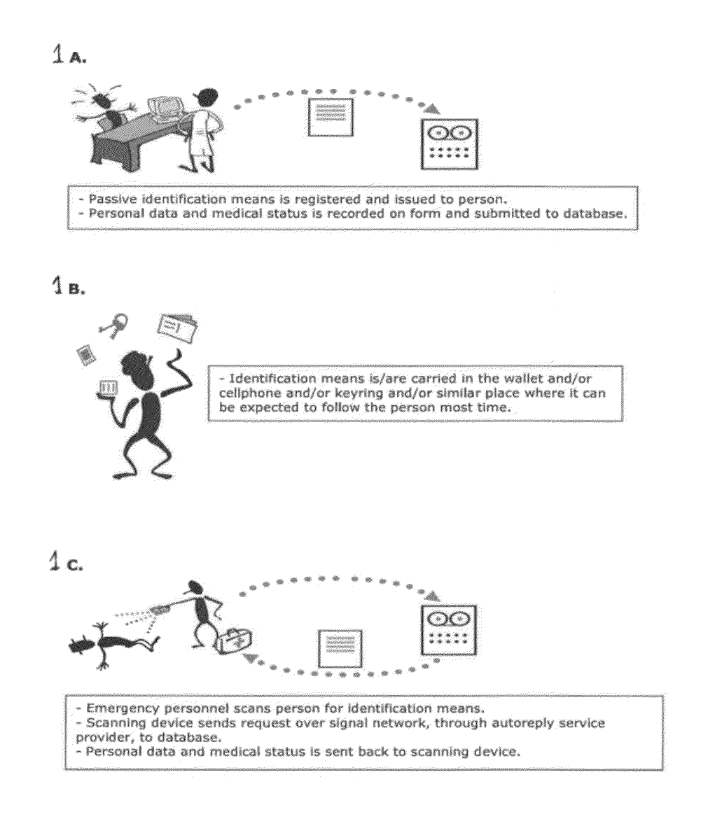

In the appended FIGS. 1a to 1c, the different components of the arrangement, as well as the steps of the method are illustrated schematically.

### DETAILED DESCRIPTION OF EMBODIMENTS

The present invention relates to an arrangement for identification of the medical status of a person in case of an accident.

The arrangement comprises:

A database where information regarding a specific person is stored. The information is for example collected at the local clinic, hospitals or service centres where the relevant information is filled in electronically or on a paper and later on transferred to the database by submitting a standard form with required details. The information is specified by the person and/or the doctor and limited to medical facts regarding medical status and/or medicaments taken on a regular basis by the person of relevance in case of emergency treatment of the person involved in an accident. In order to ensure the personal integrity, the data base is a stand-alone, separate system and not merged with any other system to which a potential attack could occur.

The database could preferably comprise a picture of the person together with the information regarding the medical status of the person in order to make it possible to confirm the match between the person and the information stored in the database. The picture could be easily taken by a web camera at the local hospital.

Continuous updates of the information in the database could be done by the doctor(s) provided with the required authorization, for example a personal password, the reading of patient's existing id code, etc.

The location of the database is preferably decided based on the national safety requirements as well as the desired safety level to be able to extract information from the database.

Identification means that make it possible to identify the person and collect the relevant information in the database for the identified person. The identification means could for example be a RF ID code card arranged on a sticky tag and attached on a cell phone, hanging it on a key ring, a credit card or carried in a wallet. Preferably, the RF ID code should be carried by all persons, and the identification means for infants, when being outdoors and possibly indoors, could for example be carried by the infant and/or the parents or share information on their care-taker/s RFID code/s. Furthermore, a special colour/mixture of colours could also be used in order to make the identification means easily visible. Examples of information of interest to store in the database are; picture; name; gender; age; height; weight; race, blood type; heart condition; allergy; on prescribed medication; medical history; diabetic; surgeries; organ donations, organ donor etc. However, the RF ID code should not be something you could identify yourself with—NOT be used as an ID-card. Nor should the information in the database consist of details that could be of any use by a third party.

Preferably data for as many citizens as possible is included in the database and provided with the identification means even though they are perfectly healthy. The fact that also healthy citizens are included will also assist in emergency situations since the arrangement will confirm that the person is healthy and no special considerations must be taken before treatment of the injured person.

The identification means is a passive unique id without any transmitting/receiving means or medical or personal information.

The time required for the additional work related to the entering of the relevant medical information in the database and to get the required identification means is about 5 minutes. The 5 minutes makes it possible to enter the data for the first time at the doctor's clinic, and it takes less than 10 seconds to put the RF ID code card in your wallet and, if so, less than 3 minutes to apply the RF ID code sticker on the cell phone or hang it on a key ring. By putting the RF ID on either or all of these places it will cover most people's ability to wear the identification means.

A signal network for transmitting the required information to and from the database.

A scanning device that is able to scan one or more injured persons to read the identification means. The scanning device should preferably be able to scan the person or persons from a distance exceeding 10 metres, for example 50 metres, in order to minimize the time from scanning to the required medical action could be started. Preferably no physical contact or movement of the person is required. The scanning device is either permanently installed in for example an ambulance or helicopter or a portable hand held unit. Scanning devices could be arranged in for example ambulances, police vehicles, fire fighting vehicles, hospital emergency rooms etc. The scanning device furthermore comprises a transmitter and a receiver and a verifying code so that after the initial scanning of the person or persons the scanned information from the identification means is transmitted over an auto reply service with a request for delivering the desired information relating to the identification means from the database. After verification that the scanning device has the correct verifying code and, if the code is accepted, delivers the information stored in the database relating to the identification means of the scanned person or persons back to the scanning device that comprises a display for displaying the result. Only the information entered in the special software in the database and of importance in an emergency situation is delivered to the scanning device.

The scanning device could with advantage be combined with existing emergency equipment. For example with a pulse oximeter.

An auto reply service provider that verifies the scanned and transmitted request from the scanning device to the database, retrieves the information from the database and sends it to the scanning device.

Preferably the scanning device, at its first start-up, is checked and authorized by the auto reply service provider while future verification id for example could be the transmitting sim-card, or similar, in combination with the scanning device's unique identity.

The transmitter/receiver is for example using the signal network HSPA (High speed Packet Access)/WCDMA (Wideband Code Division Multiple Access)/EDGE (Enhanced Data rates for GSM Evolution)/GPRS (General Packet Radio Service)/SKYPE, or satellites, OR RADIO FREQUENCY for transfer of the information between the scanning device and the data base.

For example the information from the database, transmitted by the signal network, could be in the form of a text/SMS-message and with connecting/active links that could be displayed by the scanning device.

The time from scanning the identification means to receiving the full information on the scanning device should preferably not exceed 10 seconds.

In one preferred embodiment of the arrangement, the identification means are an RF ID and the scanning device an EMT scanning device that is able to read the RF ID from the desired distance.

The arrangement according to the invention will neither be a guaranteed system which should be taken for granted, but a possible short-cut to the right treatment in case of an emergency situation where the medical status of a person could be of great importance for which emergency treatment actions that are suitable, or in worst case devastating for the injured person. The standard procedure of giving an emergency treatment should be the normal way to treat a patient.

The embodiments described above could of course be modified in many different ways without departing from the scope of the invention that is defined by the appended claims.

1. Arrangement for identification of the medical status of a person in case of an accident, said arrangement comprises:
a database where information regarding a specific persons medical status and/or medicaments taken on a regular basis by the person of relevance in case of emergency treatment is stored;
passive identification means that make it possible to distinguish a person through a unique id/code and collect the relevant information in the database for the identified person;
a signal network for transmitting the required information to and from the database;
a scanning device that is able to scan one or more injured persons to read the identification means, said scanning device also comprises a transmitter/receiver communicating with the database and displays information;
an auto reply service provider that verifies the scanned and transmitted request from the scanning device to the database, retrieves the information from the database and sends it to the scanning device;
wherein, in case of an accident, the scanning device is used for scanning the injured person and when the identification means is indicated immediately communicate with the database via the signal network and the auto reply service provider receive information regarding the medical status of the person scanned.

2. Arrangement according to claim 1, wherein said arrangement furthermore comprises a reader/issuer of identifications means that records the unique code for the person being issued with said identification means.

3. Arrangement according to claim 1, wherein said arrangement furthermore comprises a standard software form that is used for filling in the medical status of a person before it after verification is submitted to the database where the information is stored.

4. Arrangement according to claim 2, wherein said arrangement furthermore comprises a standard software form that is used for filling in the medical status of a person before it after verification is submitted to the database where the information is stored.

5. Method for identification of the medical status of a person in case of an accident using an arrangement according to claim 1, said method comprises the steps:
a) register and issue of identification means;
b) submit medical status of a person to the database;
c) scan the person with a scanning device;
c) send a request regarding the medical status of the scanned person via a signal network through an auto reply service provider to the database;
d) verify that the scanning device is authorized to receive information from the database, and
e) send information regarding medical status from the database to the scanning device;

6. Method according to claim 5, wherein said information regarding medical status of the person is sent to the database by using a standard software form.
